(19) United States
(12) Patent Application Publication
(10) Pub. No.: US 2005/0067218 A1
(43) Pub. Date: Mar. 31, 2005

(54) Noise attenuator arrangement

(75) Inventors: Andrew Bristow, Coventry (GB); Darren Hillyer, Coventry (GB); Kevin Yeomans, Coventry (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: DUNLOP AEROSPACE LIMITED, COVENTRY (GB)

(21) Appl. No.: 10/496,165

(22) PCT Filed: Nov. 20, 2002
(86) PCT No.: PCT/GB02/05230

(30) Foreign Application Priority Data
Nov. 21, 2001 (GB) 0127952.0
Apr. 24, 2002 (GB) 0209371.4

(51) Int. Cl. F01N 1/00; F01N 1/24; F16K 17/00

(52) U.S. Cl. 181/237; 181/254; 181/255; 181/258

(57) ABSTRACT

Apparatus for the release of pressurised fluids comprising an opening through which pressurised fluids may pass and an attenuator member extending over said opening. The attenuator member operates to control the flow of said fluid and attenuate sound associated therewith.

This invention relates to an attenuator for reducing noise associated with an air bleed system particularly, but not exclusively, for a turbofan aircraft engine.

In an aircraft engine, particularly a large high bypass ratio turbofan, It may be necessary for the best operation of the engine to bleed air pressure from within the compressor. To do this, a servo-controlled valve can be provided in ducting leading from the compressor casing to the fan by-pass duct. Normally, there would be an array of several bleed valves spaced around the axis of the engine. Also, two or more valves or valve arrays may be provided at different stages of the compressor. The different valves or valve arrays are opened and dosed, or sometimes modulated, i.e. set to give a required flow rate between on and off by an engine management system. The valves are controlled by this system along with other engine parameters to optimise the operation of the engine for different operating conditions.

The release of high pressure air into the fan by-pass duct can create considerable noise and, at least in relation to valves which may open at low altitude when the aircraft is taxiing, taking off or landing, sound attenuation is required.

Patent application number GB2,132,269A discloses an attenuator for a gas turbine engine air bleed valve. The attenuator receives the plume of high pressure air from a compressor stage of the engine and has a large number of small holes which convert the stream to a multiplicity of air jets.

Patent application number EP0354161A3 discloses a muffler plate for a refrigeration system compressor with a few relatively large holes arranged round a check valve.

U.S. Pat. No. 5,906,225 shows a refrigeration system expansion valve with an elongate attenuator member made of porous material.

According to the invention, there is provided an air bleed system for a turbofan aircraft engine, the system comprising duct means for receiving air from a compressor stage of the engine and directing said air to a bypass duct of the engine valve means within the duct means for controlling the flow of said air, and a sound attenuator member extending over the duct means downstream and having apertures distributed over the member for passing said air, characterised in that the apertures of the attenuator member are arranged for the distribution of the air passing through the attenuator member to be relatively more restricted in a central region of the member than in another region outside said central region.

Said another region is an annular region extending round said central region.

Preferably, the valve and attenuator member are constructed for the pressure drop from the upstream to the downstream side of the valve member to be substantially equal to the pressure drop through the attenuator member.

The attenuator member may be positioned for a high pressure stream of air from the valve to Impinge upon said central region.

Advantageously, the attenuator member comprises a substantial number of relatively small perforations distributed over a peripheral region of the attenuator member and no or relatively few such apertures in the central region.

Preferably, the attenuator member has apertures differentially distributed over the attenuator member and porous material adjacent at least some of the apertures.

The porosity and/or thickness of the porous material may be different in different regions of the attenuator member.

The attenuator member may comprise porous material for defining said apertures, the porosity and/or thickness of the porous material being different in different regions of the attenuator member.

The porous material may be porous metallic foam.

The valve may be a bullet valve.

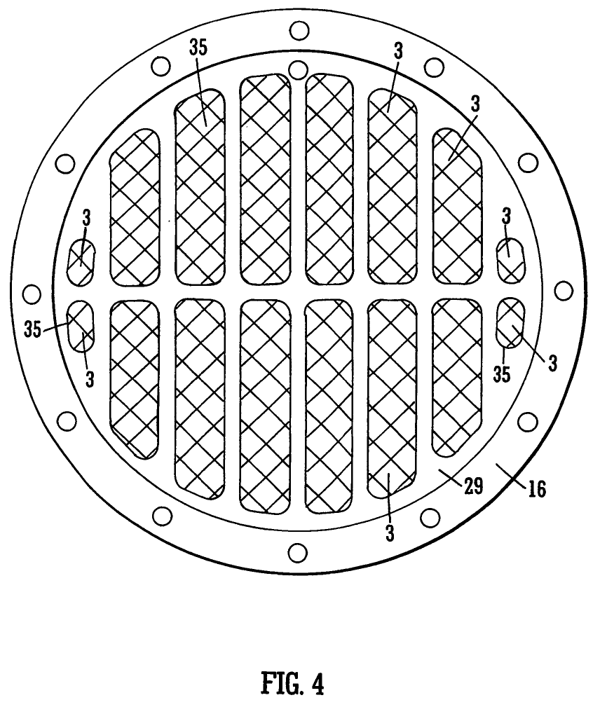

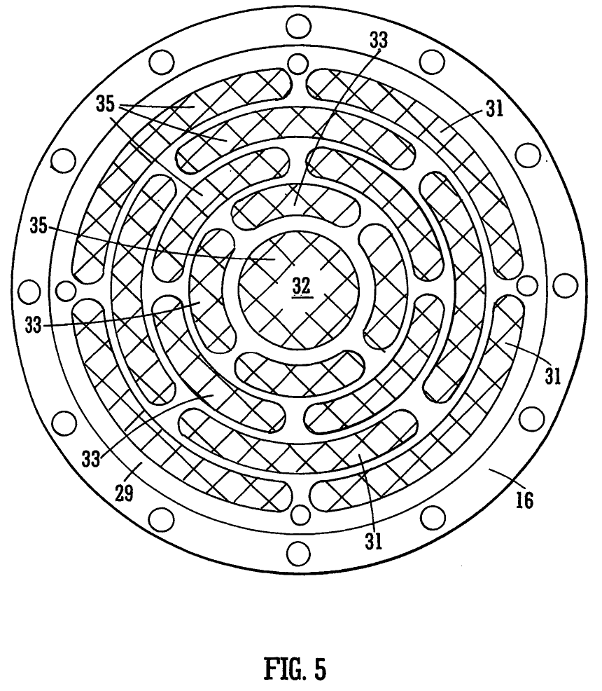

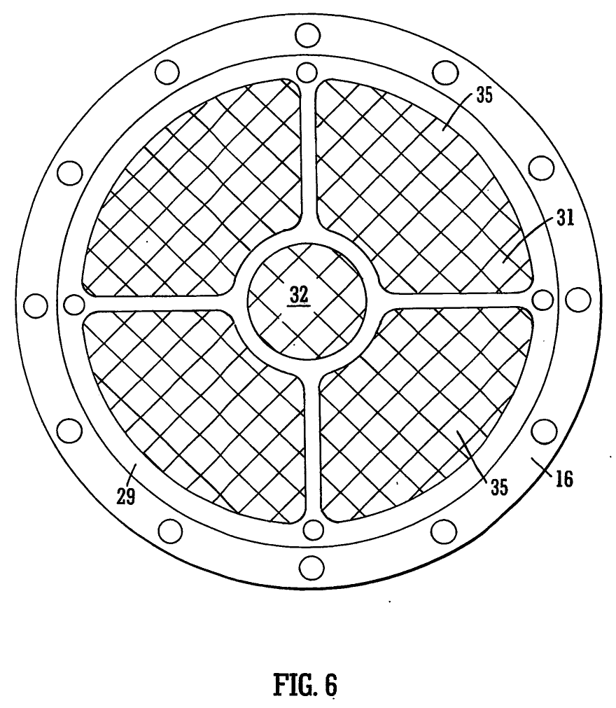

Referring to FIGS. 4 to 6, there is shown a number of alternative layouts of holes in the cover 29 of the attenuator 16. The size, shape and positioning of the holes 31, 32, 33 may be changed to suit different flow-rates of air. A Retimet foam layer 35 may be provided beneath the member 16.

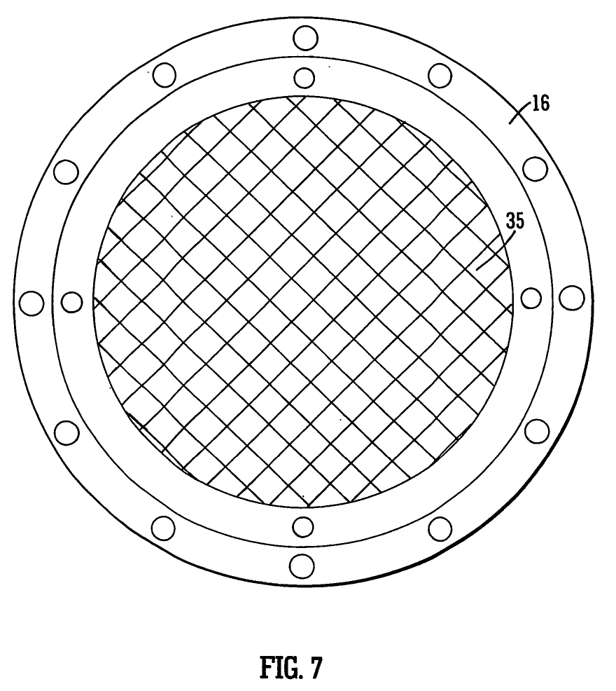

In the embodiment shown in FIG. 7, the cover 29 of the attenuator 16 is omitted and effectively replaced entirely by a self supporting layer of Retimet foam layer 35.

The metal foam 35 could incorporate different grades of foam; for example, the centre area 32 could be of a grade more restrictive to flow than the outer area.

Foams are graded with a number system representing the number of pores/cells per linear inch; e.g. 80 grade has 80 cells per inch. It is expected that the range of foams suitable for this application would be in the range 5 to 150 grade, and preferably be in the range 10 to 80 grade.

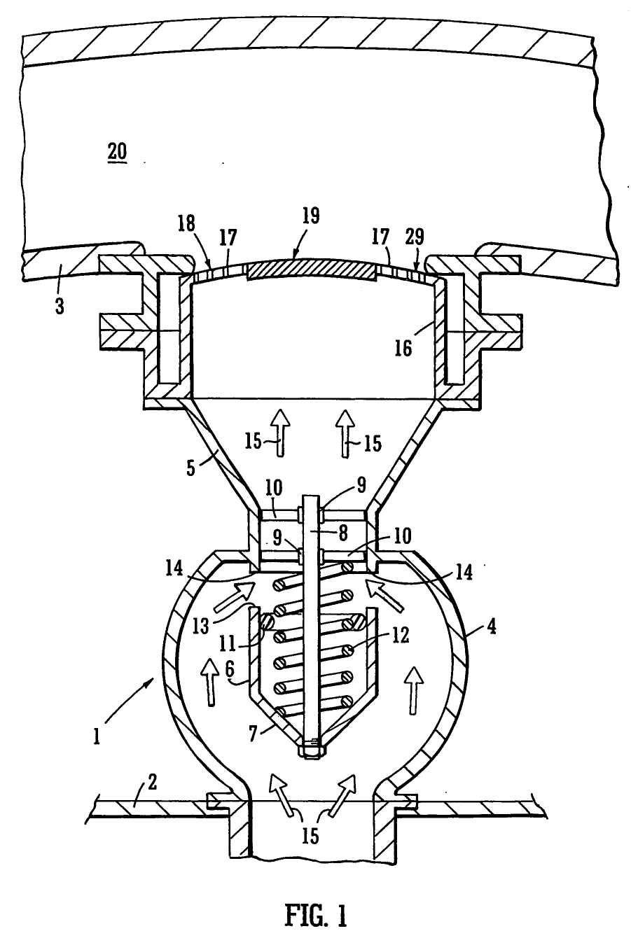

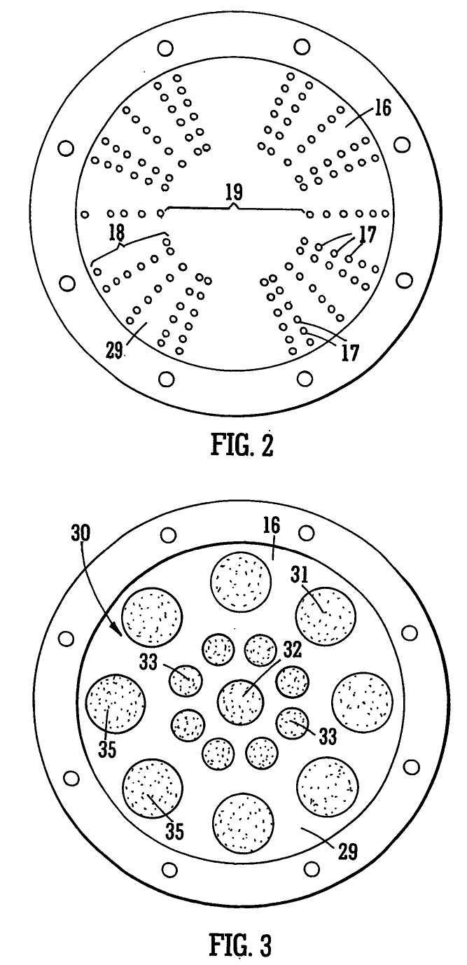

Changes of the grade of the layer of metal foam 35 of FIGS. 3 to 7 could produce different noise reduction characteristics. For example different grades of foam with different porosity would reduce different noise frequencies.

A sandwich structure of layers of foam of different grades would alternate a wider range of noise frequencies and provide improved noise reduction. Also, by using foams of different thickness one could also change the noise reduction properties by changing the flow rate. This needs to be balanced against the desired flow rate from the valve 6 and the pressure drop across the valve 6.

The layer of metallic foam 35 of FIGS. 3 to 6 may have different zones of different porosity aligned with selected holes 31, 32, 33 in the cover 29. Similarly, the inserts of metallic foam 35 of FIG. 7 can have a different porosity for different zones. In this way, one can accommodate different airflow rates or different levels of sound attenuation for different applications and thus provide greater flexibility in the design of the characteristics of the attenuator.

It is to be understood that the layer 35 of metallic foam shown in FIGS. 3 to 6 may be replaced by individual inserts of metallic foam that are secured in each of the holes 31, 32, 33.

It may be possible to use a mat of metal or other fibres to produce a similar effect to the metal foam to control flow rate and pressure drop across the valve 6 to reduce noise. Such a mat could be a woven or non-woven fibre structure or fabric.

The cover 29 might be required or desirable in some of those applications where a foam metal layer is used, for example, to restrict air flow more in some areas than in other areas. But in other applications the cover 29 may not be needed. Where a cover 29 is used it may be of any support structure such as perforated metal or plastics material or could simply comprise two mutually orthogonal sets of parallel wires or wire mesh to retain the foam metal layer 35 in place.

1. An air bleed system for a turbofan aircraft engine, the system comprising duct means for receiving air from a compressor stage of the engine and directing said air to a bypass duct of the engine, valve means within the duct means for controlling the flow of said air, and a sound attenuator member extending over the duct means downstream of the valve means and having apertures distributed over the member for passing said air, characterised in that the apertures of the attenuator member are arranged for the distribution of the air passing through the attenuator member to be relatively more restricted in a central region of the member than in another region outside said central region.

2. A system according to claim 1, wherein said another region is an annular region extending round said central region.

3. A system according to claim 1, wherein the valve and attenuator member are constructed for the pressure drop from the upstream to the downstream side of the valve member to be substantially equal to the pressure drop through the attenuator member.

4. A system according to claim 1, wherein the attenuator member is positioned for a high pressure stream of air from the valve to impinge upon said central region.

5. A system according to claim 1, wherein the attenuator member comprises a substantial number of relatively small perforations distributed over a peripheral region of the attenuator member and no or relatively few such apertures in the central region.

6-10. (canceled).

11. A system according to claim 1, wherein the attenuator member comprises porous material having pores extending through the attenuator member to define said apertures.

12. A system according to claim 11, wherein the porous material is porous metallic foam.

13. A system according to claim 1, wherein the attenuator member has apertures differentially distributed over the attenuator member and porous material adjacent at least some of the apertures.

14. A system according to claim 13, wherein the porous material is porous metallic foam.

15. A system according to claim 13, wherein the porosity of the porous material is different in different regions of the attenuator member.

16. A system according to claim 13, wherein the thickness of the porous material is different in different regions of the attenuator member.

17. Apparatus according to claim 1, wherein the valve is a bullet valve.
